(19) United States
(12) Patent Application Publication
(10) Pub. No.: US 2022/0292443 A1
(43) Pub. Date: Sep. 15, 2022

(54) PRODUCT MANAGEMENT SYSTEM, PRODUCT MANAGEMENT METHOD, AND NON-TRANSITORY COMPUTER READABLE MEDIUM STORING PROGRAM

(71) Applicant: NEC Platforms, Ltd., Kawasaki-shi, Kanagawa (JP)

(72) Inventor: Hideki MATSUURA, Kanagawa (JP)

(73) Assignee: NEC Platforms, Ltd., Kawasaki-shi, Kanagawa (JP)

(21) Appl. No.: 17/632,320

(22) PCT Filed: Jul. 29, 2020
(86) PCT No.: PCT/JP2020/029118

§ 371 Date: Feb. 2, 2022

(30) Foreign Application Priority Data
Aug. 20, 2019 (JP) 2019-150500

(51) Int. Cl. G06Q 10/08; G06K 7/10

(52) U.S. Cl. CPC G06Q 10/087; G06K 7/10366

(57) ABSTRACT

A product management system includes a plurality of first antennas arranged in a shelf board of a display shelf in an orderly manner and configured to receive a radio wave from an RFID tag attached to a product displayed on the display shelf, a tag location unit that locates a product based on a position of each of the first antennas and a receiving state of a radio wave transmitted from the same RFID tag at each of the first antennas, a product determination unit that determines, based on information for specifying an expiration date of the product transmitted from the RFID tag by the radio wave, whether or not a remaining period from a present time to the expiration date satisfies a predetermined condition, and a display control unit that performs control so as to display a position of the product whose remaining period satisfies the predetermined condition.

### TECHNICAL FIELD

The present invention relates to a product management system, a product management method, and a program.

### BACKGROUND ART

In recent years, products have been increasingly managed by using RFID (radio frequency identifier) tags. For example, Patent Literature 1 discloses a technology for managing stocks of products placed on shelves by disposing antennas on the bottom surfaces of the shelves.

It should be noted that, in stores selling commodities, when commodities have expiration dates (e.g., best-before dates), it is necessary to remove commodities whose expiration dates have expired from the display shelves. In order to do so, it is necessary to find out, among the displayed commodities, which commodities are those to be removed. Therefore, for example, store clerks find commodities to be removed by visually checking, for all the commodities, information about dates and times (hereinafter also referred to as date-and-time information), such as best-before dates, recorded (e.g., printed) on the commodities.

In this regard, Patent Literature 2 discloses a commodity management system using RFID tags. In this commodity management system, a tag reading device reads date-and-time information recorded in a tag attached to a commodity, determines whether or not the commodity should be removed, and outputs the result of the determination.

### CITATION LIST

### Patent Literature

Patent Literature 1: Published Japanese Translation of PCT International Publication for Patent Application, No. 2010-534998
Patent Literature 2: Japanese Unexamined Patent Application Publication No. 2005-178964

### SUMMARY OF INVENTION

### Technical Problem

According to the technology disclosed in Patent Literature 2, a person who takes charge of commodities is relieved of the task of visually checking date-and-time information of all the commodities, thus making it possible to reduce the amount of required labor. However, in the technology disclosed in Patent Literature 2, it is necessary to hold the tag reading device over each one of all the commodities arranged on shelves one by one, thus requiring much effort.

Therefore, one of the objects to be attained by example embodiments disclosed in this specification is to provide a product management system, a product management method, and a program capable of easily finding products to be removed.

### Solution to Problem

A product management system according to a first aspect includes:

a plurality of first antennas arranged in a shelf board of a display shelf in an orderly manner and configured to receive a radio wave from an RFID tag attached to a product displayed on the display shelf;

tag location means for locating the product based on a position of each of the first antennas and a receiving state of a radio wave transmitted from the same RFID tag at each of the first antennas;

product determination means for determining, based on information for specifying an expiration date of the product transmitted from the RFID tag by the radio wave, whether or not a remaining period from a present time to the expiration date satisfies a predetermined condition; and

display control means for performing control so as to display a position of the product whose remaining period satisfies the predetermined condition.

A product management method according to a second aspect includes:

locating a product displayed on a display shelf based on positions of a plurality of first antennas arranged in a shelf board of the display shelf in an orderly manner and configured to receive a radio wave from an RFID tag attached to the product and a receiving state of a radio wave transmitted from the same RFID tag at each of the first antennas;

determining, based on information for specifying an expiration date of the product transmitted from the RFID tag by the radio wave, whether or not a remaining period from a present time to the expiration date satisfies a predetermined condition; and

performing control so as to display a position of the product whose remaining period satisfies the predetermined condition.

A program according to a third aspect causes a computer to perform:

a tag location step of locating a product displayed on a display shelf based on positions of a plurality of first antennas arranged in a shelf board of the display shelf in an orderly manner and configured to receive a radio wave from an RFID tag attached to the product and a receiving state of a radio wave transmitted from the same RFID tag at each of the first antennas;

a product determination step of determining, based on information for specifying an expiration date of the product transmitted from the RFID tag by the radio wave, whether or not a remaining period from a present time to the expiration date satisfies a predetermined condition; and

a display control step of performing control so as to display a position of the product whose remaining period satisfies the predetermined condition.

### Advantageous Effects of Invention

According to the above-described aspect, it is possible to provide a product management system, a product management method, and a program capable of easily finding products to be removed.

### BRIEF DESCRIPTION OF DRAWINGS

FIG. 1 is a block diagram showing an example of a configuration of a product management system according to an outline of an example embodiment;

FIG. 2 is a schematic diagram showing an example of a display shelf;

FIG. 3 is a block diagram showing an example of a configuration of a product management system according to an example embodiment;

FIG. 4 is a cross-sectional view of the display shelf taken along a cutting line IV-IV in FIG. 2;

FIG. 5 is a plan view of a shelf board;

FIG. 6 is a front view of a rear board;

FIG. 7 is a perspective view of a display shelf;

FIG. 8 is a block diagram showing an example of a functional configuration of a terminal device;

FIG. 9 is a schematic diagram showing an example of an image displayed by a display control unit;

FIG. 10 is a schematic diagram showing an example of an image displayed by the display control unit;

FIG. 11 is a schematic diagram showing a light-emitting unit provided in a display shelf;

FIG. 12 is a schematic diagram showing an example of a display of products to be removed;

FIG. 13 is a schematic diagram showing an example of a display of a product to be removed;

FIG. 14 is a schematic diagram showing an example of a table for managing receiving strengths;

FIG. 15 is a schematic diagram showing an example of a table for managing receiving strengths;

FIG. 16 is a schematic diagram showing an example of a hardware configuration of a terminal device; and

FIG. 17 is a flowchart showing an example of a flow of operations performed by a product management system according to an example embodiment.

### DESCRIPTION OF EMBODIMENTS

### Outline of Example Embodiment

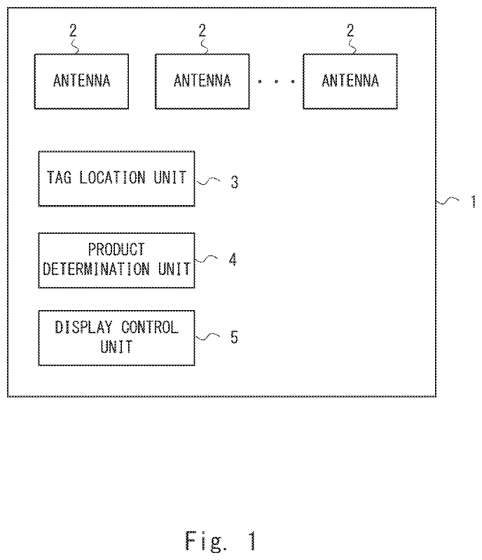

Prior to describing an example embodiment in detail, an outline of the example embodiment will be described. FIG. 1 is a block diagram showing an example of a configuration of a product management system 1 according to the outline of the example embodiment. As shown in FIG. 1, the product management system 1 includes a plurality of antennas 2, a tag location unit 3, a product determination unit 4, and a display control unit 5.

The antennas 2 are arranged in a shelf board of a display shelf in an orderly manner. Note that the shelf board is a component that forms a horizontal surface in the display shelf. Note that the shelf board may be a component that constitutes a surface on which products are displayed, or a component that constitutes a ceiling of a display space. At least one product is displayed in the display shelf. Note that each product is provided with an RFID tag attached thereto in which information for specifying at least an expiration date of the product is stored. Note that the information for specifying the expiration date of a product is, for example, but not limited to, information indicating the expiration date of the product (specifically, for example, date-and-time information). In the case where, for example, identification information for uniquely specifying an expiration date (e.g., an ID for identifying a product) and the expiration date are managed while being associated with each other in a database or the like, the identification information may be stored in the RFID tag. The antennas 2 receives radio waves from the RFID tags attached to the displayed products. In this way, the product management system 1 can acquire information for specifying the expiration date of a product transmitted from the RFID tag thereof.

The tag location unit 3 locates a displayed product (i.e., determines the place of a displayed product) based on the position of each of the antennas 2 and the receiving state of a radio wave transmitted from the same RFID tag at each of the antennas 2. The radio wave transmitted from the same RFID tag is acquired (i.e., received) by the antennas 2 disposed at various positions. Therefore, the receiving state of the radio wave transmitted from this RFID tag at each of the antennas 2 changes according to the position of the RFID tag, which has transmitted the radio wave, i.e., according to the position of the product. Therefore, it is possible to specify the position of the product based on the receiving state at each of the antennas 2 and the predetermined positions at each of which a respective one of the antennas 2 is disposed.

The product determination unit 4 determines, based on information for specifying the expiration date of the product transmitted from the RFID tag by the radio wave, whether or not the remaining period from the present time to the expiration date satisfies a predetermined condition. This predetermined condition is a condition for extracting (i.e., finding) a product(s) to be removed. In the case where the products are food, the expiration dates are, for example, but not limited to, the best-before dates of the products. That is, the expiration date can be any time limit before which the product can be considered to be valid (e.g., edible) in light of a predetermined criterion.

The display control unit 5 performs control so as to display the position(s) of a product(s) of which product determination unit 4 has determined that the remaining period(s) satisfies the predetermined condition. That is, the display control unit 5 performs control so as to display the position(s) of a product(s) to be removed.

According to the product management system 1, the position(s) of a product(s) whose remaining period(s) from the present time to the expiration date(s) satisfies the predetermined condition is automatically specified. Therefore, a person who takes charge of products does not have to check the expiration dates of all the products displayed on the display shelf by visually examining all the products. Further, the person who takes charge of products does not need to perform the operation for reading the RFID tags of all the products one by one. Therefore, according to the product management system 1, it is possible to easily find a product(s) to be removed.

### Details of Example Embodiment

Next, details of an example embodiment will be described.

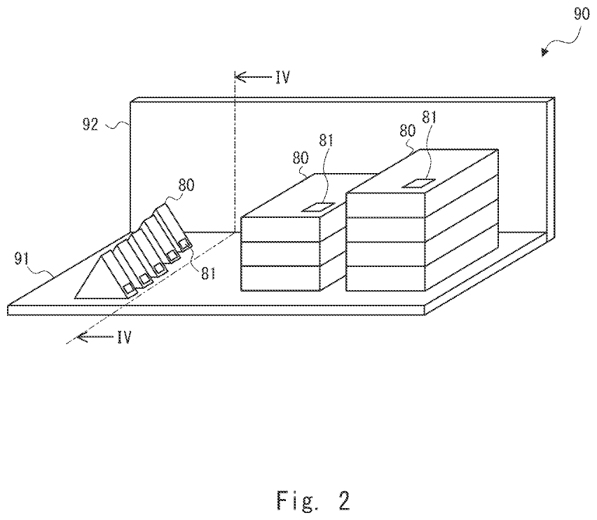

FIG. 2 is a schematic diagram showing an example of a display shelf. In the example shown in FIG. 2, the display shelf 90 includes a shelf board 91 that constitutes a horizontal surface and a rear board 92 that constitutes a vertical surface. Note that the shelf board 91 does not necessarily have to be precisely horizontal, and the rear board 92 does not necessarily have to be precisely vertical. The display shelf 90 is installed, for example, in a store selling commodities (specifically, for example, a convenience store, a supermarket, etc.). Products 80, which are commodities for sale, are displayed on the shelf board 91. The products 80 may be displayed while being stacked on top of each other as shown in FIG. 2. In this example embodiment, as an example, the products 80 are food and drink.

Each of the products 80 is provided with an RFID tag 81 attached thereto. In the RFID tag 81, the best-before date and time of the product 80 and identification information for uniquely identifying the product 80 are stored in advance. Note that this example embodiment will be described on the assumption that the best-before date and time are stored in advance in the RFID tag 81. However, in the case where the identification information of the product 80 and the best-before date and time of the product 80 are managed while being associated with each other in a DB server 500 (which will be described later), the best-before date and time do not need to be stored in the RFID tag 81 in advance.

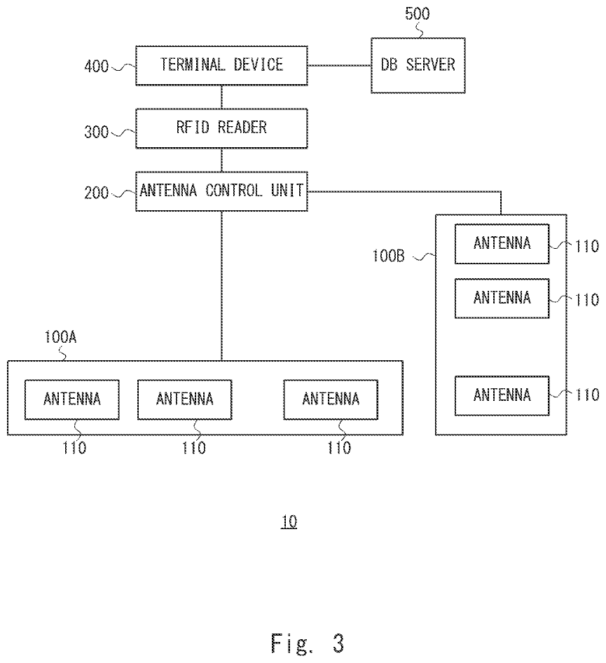

FIG. 3 is a block diagram showing an example of a configuration of a product management system 10 according to an example embodiment. As shown in FIG. 3, the product management system 10 includes an array antenna 100A, an array antenna 100B, an antenna control unit 200, an RFID reader 300, a terminal device 400, and a DB server 500.

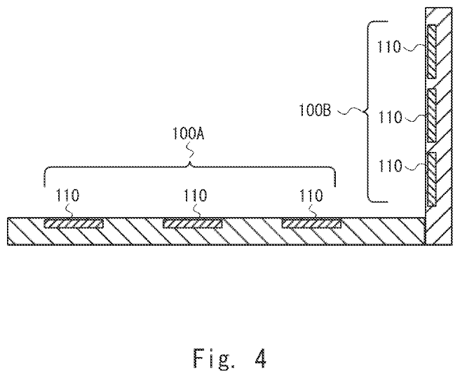

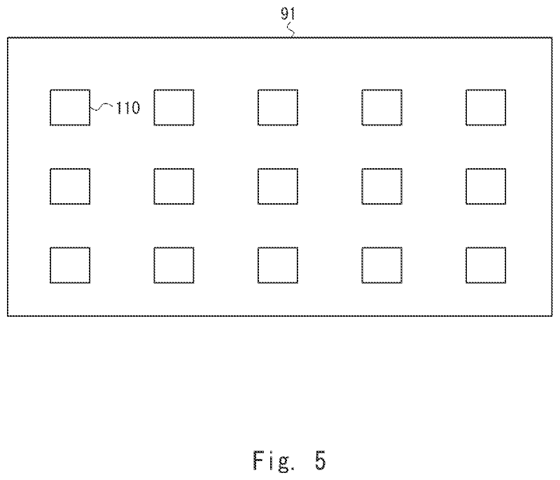

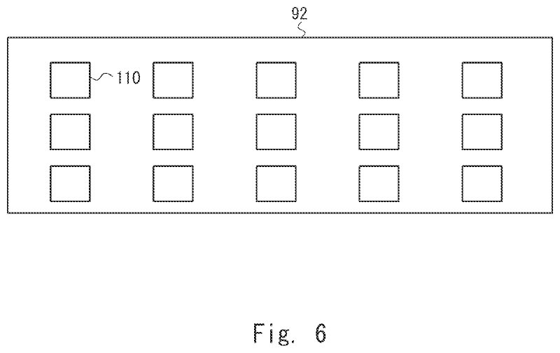

The array antennas 100A and 100B are provided in the display shelf 90. FIG. 4 is a cross-sectional view of the display shelf 90 taken along a cutting line IV-IV in FIG. 2. Further, FIG. 5 is a plan view of the shelf board 91. Further, FIG. 6 is a front view of the rear board 92. Note that, in the following description, when the array antennas 100A and 100B are referred to without distinguishing them from each other, they will be referred to as the array antennas 100.

The array antenna 100A is a group of a plurality of antennas 110 arranged in an orderly manner. The array antenna 100A is laid out in the shelf board 91 of the display shelf. The array antenna 100A receives radio waves output from the RFID tags 81 attached to the products 80 displayed in the display shelf 90. In this example embodiment, as shown in FIG. 5, in the array antenna 100A, the antennas 110 are two-dimensionally arranged in the shelf board 91. That is, the array antenna 100A includes N₁×M₁ antennas 110 in total in an arrangement in which there are N₁ rows (three rows in the example shown in FIG. 5) in the vertical direction and there are M₁ rows (five rows in the example shown in FIG. 5) in the horizontal direction. Note that although 15 antennas 110 are shown in the example shown in FIG. 5, the number of antennas 110 included in the array antenna 100A is not limited to this number. The number of antennas 110 included in the array antenna 100A is preferably large in order to improve the accuracy of the locating of the product 80 (the RFID tag 81), but is not limited to any particular number.

Similarly, the array antenna 100B is a group of a plurality of antennas 110 arranged in an orderly manner. The array antenna 100B is laid out in the rear board 92 of the display shelf. The array antenna 100B receives radio waves output from the RFID tags 81 attached to the products 80 displayed in the display shelf 90. In this example embodiment, as shown in FIG. 6, in the array antenna 100B, the antennas 110 are two-dimensionally arranged in the shelf board 91. That is, the array antenna 100B includes N₂×M₂ antennas 110 in total in an arrangement in which there are N₂ rows (three rows in the example shown in FIG. 6) in the vertical direction and there are M₂ rows (five rows in the example shown in FIG. 5) in the horizontal direction. Note that although 15 antennas 110 are shown in the example shown in FIG. 6, the number of antennas 110 included in the array antenna 100B is not limited to this number. The number of antennas 110 included in the array antenna 100B is preferably large in order to improve the accuracy of the locating of the product 80 (the RFID tag 81), but is not limited to any particular number.

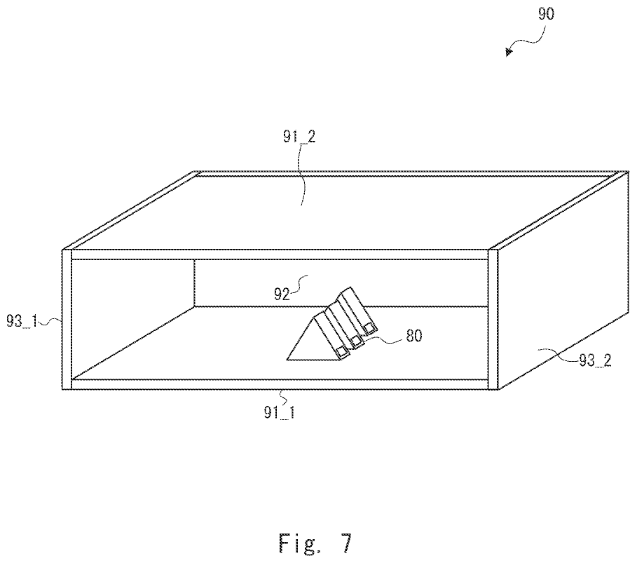

Note that although the array antenna 100A is provided in the shelf board 91 disposed under the displayed products 80 in this example embodiment, it may be provided in the shelf board 91 disposed above the displayed products 80. That is, the array antenna 100A may be provided below the display space or above the display space. Specifically, the array antenna 100A may be provided in the lower-side shelf board 91_1 or in the upper-side shelf board 91_2 (see FIG. 7).

Further, although the array antenna 100B is provided on the rear surface of the display shelf in this example embodiment, it may be provided on a side surface of the display shelf. That is, the array antenna 100B may be provided on the side of the display space. Specifically, the array antenna 100B may be provided in the rear board 92, or may be provided in a side board 93_1 or a side board 93_2 (see FIG. 7).

In this example embodiment, the antennas 110 are also used as transmitting antennas that transmit radio waves to the RFID tags 81. However, a transmitting antenna(s) that transmits radio waves to the RFID tags 81 may be provided separately from the array antennas 100. Note that, in such a case, the transmitting antenna(s) may be disposed in an arbitrary place(s).

A signal transmitted from an RFID tag 81 may be received simultaneously at each of the antennas 110 constituting the array antenna 100, or it may be received at each of the antennas 110 one after another. In the case where a signal transmitted from an RFID tag 81 is received at each of the antennas 110 one after another, the transmission of the signal from the RFID tag 81 is repeated as many times as the number of antennas 110, and each time the signal is transmitted, the antenna 110 that actually receives the signal is switched from one to another. Note that, in this case, the switching of the antenna 110 that actually receives the signal is performed by the antenna control unit 200.

The antenna control unit 200 is connected to the RFID reader 300 and the array antennas 100, and is a control circuit that controls the transmission/reception of radio waves using the array antennas 100. Note that the antenna control unit 200 may be built into (e.g., disposed inside) the RFID reader 300.

The antenna control unit 200 corresponds to the tag location unit 3 shown in FIG. 1, and locates a displayed product 80 (an RFID tag 81) based on the position of each of the antennas 110 and the receiving state of the radio wave transmitted from the same RFID tag 81 (i.e., the RFID tag 81 to be located) at each of the antennas 110. The radio wave transmitted from the same RFID tag 81 is acquired by the antennas 110, which are disposed at various positions, and the receiving state (e.g., the receiving strength, the receiving time, or the phase) at each of these antennas 110 differs according to the positional relation between the RFID tag 81 and the antenna 110. Therefore, the antenna control unit 200 locates the product 80 (the RFID tag 81) based on the receiving state at each of the antennas 110. Note that a function equivalent to that of the tag location unit 3 may be provided by the terminal device 400. In such a case, the terminal device 400 acquires information indicating the receiving state at each of the antennas 110 from the antenna control unit 200, and locates the displayed product 80 (the RFID tag 81) based on the position information of each of the antennas 110 and the aforementioned acquired information.

Note that, in this example embodiment, the antenna control unit 200 locates a product 80 (an RFID tag 81) on the horizontal plane based on the receiving state at each of the antennas 110 included in the array antenna 100A. Further, the antenna control unit 200 locates the product 80 (the RFID tag 81) in the height direction based on the receiving state at each of the antennas 110 included in the array antenna 100B. As described above, the antenna control unit 200 three-dimensionally locates the product 80 based on the position of each of the antennas 110 and the receiving state of the radio wave transmitted from the same RFID tag 81 at each of the antennas 110. Therefore, in this example embodiment, it is possible to determine not only the position on the horizontal plane but also the position in the height direction, so that it is possible to locate the product 80 in a specific manner even when the products 80 are stacked on top of each other on the display shelf.

For example, the antenna control unit 200 estimates the position of the RFID tag 81, of which the position is to be determined, based on the receiving strength of the radio wave transmitted from the RFID tag 81 at each of the antennas 110. This is a locating method using the fact that, in general, the closer the RFID tag 81 is to the antenna 110, the higher the receiving strength becomes. Since the positions of the antennas 110 are determined in advance as shown in FIG. 5 or 6, the position of the RFID tag 81 is determined by checking (i.e., measuring) the receiving strength at each of the antennas 110. Note that the antennas 110 may be antennas having directivity in the receiving direction. That is, each of the antennas 110 may have a higher receiving sensitivity for radio waves coming from a specific direction (e.g., a direction perpendicular to the surface on which the antennas 110 are laid out) than those in other directions.

Note that the antenna control unit 200 may locate the RFID tag 81 (i.e., determine the position of the RFID tag 81) by any other known method. For example, the antenna control unit 200 may calculate the position of the RFID tag 81 based on differences between times at which a radio wave arrives at the plurality of antennas 110 of the array antennas 100.

The RFID reader 300 is a control circuit that communicates with the RFID tag 81 in accordance with a predetermined communication protocol and reads information stored in the RFID tag 81. The RFID reader 300 outputs the read information to the terminal device 400. In this example embodiment, the RFID reader 300 outputs, along with the position information of the RFID tag 81 obtained by the antenna control unit 200, information (identification information and best-before date and time) stored in this RFID tag 81 to the terminal device 400. Note that the RFID reader 300 reads the information of the RFID tag 81 of each of a plurality of products 80 displayed in the display shelf 90 one by one in a time-shared manner by using a known anti-collision technique.

The DB server 500 is a database server in which information about each product 80 is stored. For example, the DB server 500 manages various information items about the product in association with the identification information of the product 80. For example, the DB server 500 may store manufacturing dates and times of products, the types of the products, the sizes of the products, the shapes of the products, information about defects of products, and the like. Further, as described above, the DB server 500 may store best-before dates and times of products 80 in association with identification information of the products 80. In such a case, even when the best-before date is not acquired from the RFID tag 81, the best-before date of the product can be checked. Note that in the case where the best-before date is stored in the RFID tag 81, it is possible to determine whether or not the product 80 should be removed without referring to the DB server 500. Therefore, in this case, the product management system 10 may not include the DB server 500.

The terminal device 400 is an apparatus that manages a product 80 based on information acquired from the RFID tag 81 of that product 80. In this example embodiment, the terminal device 400 is connected to the RFID reader 300 and the DB server 500 so that it can communicate with them. Note that although the terminal device 400 acquires information about the product 80 managed in the database by communicating with the DB server 500 in the configuration shown in FIG. 2, the terminal device 400 itself may include such a database. That is, the DB server 500 is not indispensable in the product management system 10.

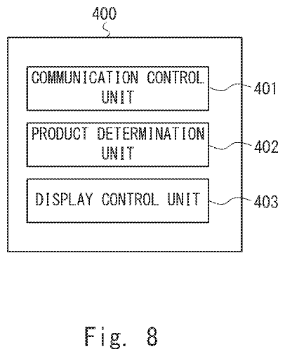

FIG. 8 is a block diagram showing an example of a functional configuration of the terminal device 400. As shown in FIG. 8, the terminal device 400 includes a communication control unit 401, a product determination unit 402, and a display control unit 403.

The communication control unit 401 communicates with other apparatuses and acquires information from the other apparatuses. Specifically, the communication control unit 401 acquires, from the RFID reader 300, information stored in an RFID tag 81 and the position information of this RFID tag 81. Further, the communication control unit 401 acquires information about a product 80 from the DB server 500 by using the identification information of this product 80 as a search key.

The product determination unit 402 determines, based on the information acquired from the RFID tag 81, the best-before date of the product 80 to which this RFID tag 81 is attached. Specifically, the product determination unit 402 determines whether or not the remaining period from the present time to the best-before date and time specified from the information transmitted from the RFID tag 81 satisfies a predetermined condition. More specifically, for example, the product determination unit 402 determines whether or not the remaining period from the present time to the best-before date and time is shorter than a predetermined time. This predetermined time is a reference time for determining products to be removed. For example, when the predetermined time is six hours, the product 80 is regarded as a product to be removed from six hours before the best-before date. Note that this predetermined time may be zero. In such a case, it means that the product is not regarded as a product to be removed until the best-before date expires.

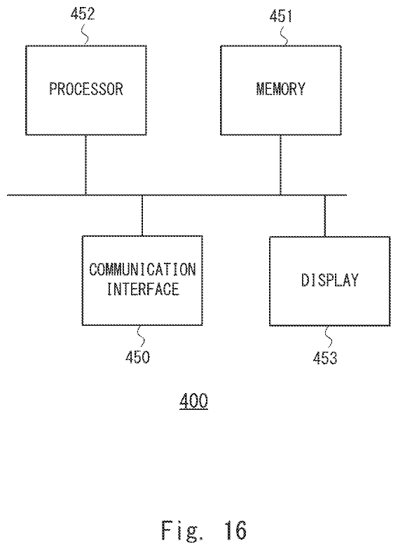

The display control unit 403 performs control so as to display the position of the product to be removed. That is, the display control unit 403 performs control so as to display the position of a product 80 of which the product determination unit 402 has determined that the above-described remaining period satisfies the predetermined condition. The display control unit 403 displays the position of the product 80, on which the above-described determination has been made, based on the acquired position information for the RFID tag 81 attached to this product 80. For example, the display control unit 403 performs control so as to display the position of the product 80 on a display 453 provided in the terminal device 400 (see FIG. 16), but it may perform control so as to display the position of the product 80 on a display of an apparatus other than the terminal device 400.

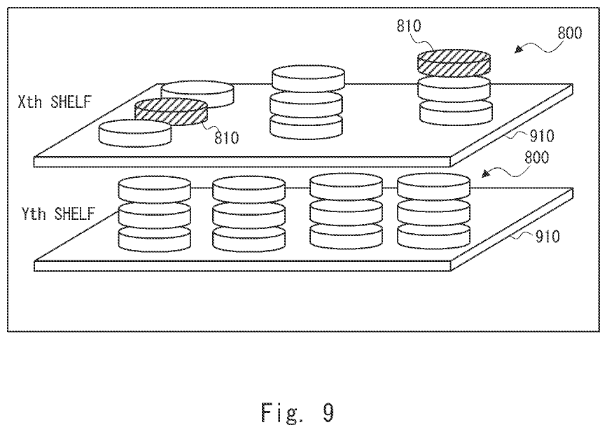

FIG. 9 is a schematic diagram showing an example of an image displayed by the display control unit 403. FIG. 9 shows an example of an image displayed on the screen of the display 453. In the example shown in FIG. 9, images 800 imitating products 80 are displayed together with images imitating display shelves 90 (specifically, images 910 imitating shelf boards 91). In particular, for the products 80 to be removed, the images 810 colored in a predetermined color are displayed at positions corresponding to the actual positions of the products 80. In this manner, the display control unit 403 displays the positions of the products 80 to be removed (specifically, the products 80 of which the remaining periods satisfy the predetermined condition) on the images imitating the display shelves 90. By the above-described displaying method, a user can easily recognize the positions of the products 80 to be removed in a visual manner.

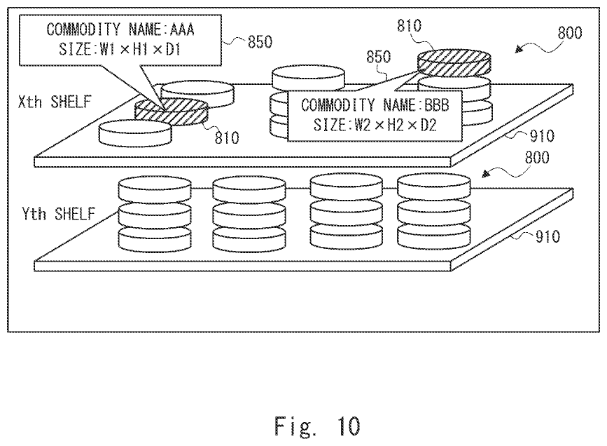

Further, as shown in FIG. 10, the display control unit 403 may display, along with the positions of the products 80 to be removed (specifically, the products 80 of which the remaining periods satisfy the predetermined condition), information pieces (e.g., information balloons) 850 about the appearances of the products 80. Note that information about appearances is, for example, stored in advance as information about products 80 in the DB server 500. The information about the appearance is any information that indicates an external feature(s) of the product 80 that can be used as a clue by which the user can find the product 80. For example, the information about the appearance may be the type of the product 80, the size of the product 80, and/or the shape of the product 80. In this way, the user can easily find the product 80 to be removed by using the information about the appearance as a clue.

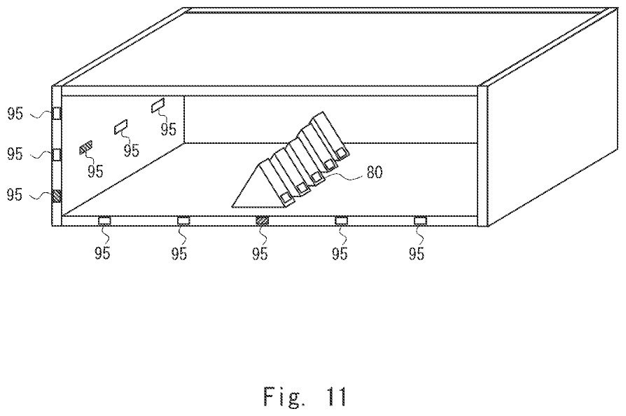

Further, the display control unit 403 may display (i.e., indicate) the position of the product 80 to be removed by emitting light from a light-emitting unit provided in the display shelf 90 instead of or in addition to displaying the above-described image on the display 453. FIG. 11 is a schematic diagram showing light-emitting units 95 provided in the display shelf 90. In the example shown in FIG. 11, the display shelf 90 includes a plurality of light-emitting units 95 arranged along the arranging direction of products. Note that the arranging direction is the direction in which a group of displayed products are arranged, and specifically includes width, depth, and height directions. Note that although the light-emitting units 95 are arranged in three directions, i.e., in the width, depth, and height directions in the example shown in FIG. 11, the light-emitting units 95 may be arranged in only one of these directions or any two of these directions. Each of the light-emitting units 95 is, for example, an LED (light-Emitting Diode). In this case, the display control unit 403 indicates the positions of products 80 to be removed (specifically, products 80 of which the remaining periods satisfy the predetermined condition) by making light-emitting units 95 corresponding to the positions of the products 80 to be removed emit light. Note that, in the example shown in FIG. 11, light-emitting units 95 with hatching represents light-emitting units 95 that are emitting light. In this way, the user can easily find the products 80 to be removed in the display shelf 90.

Note that, in the case where the number of antennas 110 included in the array antennas 100 is small, the position of the product 80 is not precisely determined, and instead the approximate position thereof is determined. However, even such determination of an approximate position is useful because the user can guess the actual position based thereon. That is, in regard to the place where a commodity of which the best-before date has already expired is displayed, if the approximate position of such a commodity is acquired, it is possible to remove that commodity, of which the best-before date has already expired, from the display shelf 90 without having to visually examining all the displayed commodities. Therefore, as compared to the case where there is no information about the positions of commodities of which the best-before dates have already expired, it is possible to improve the efficiency of the work for removing commodities of which the best-before dates have already expired.

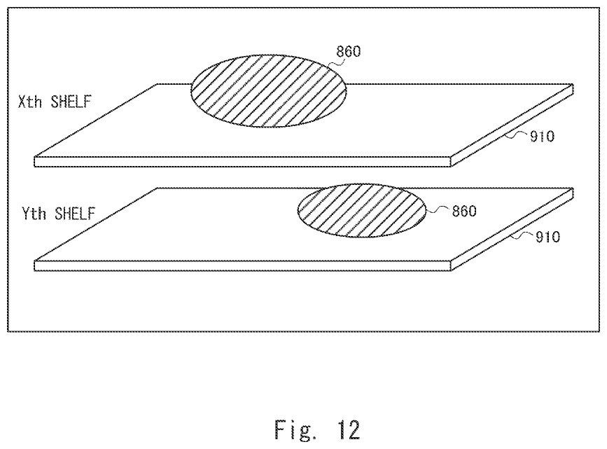

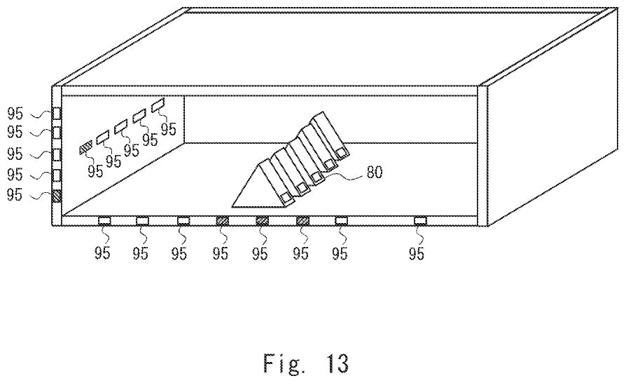

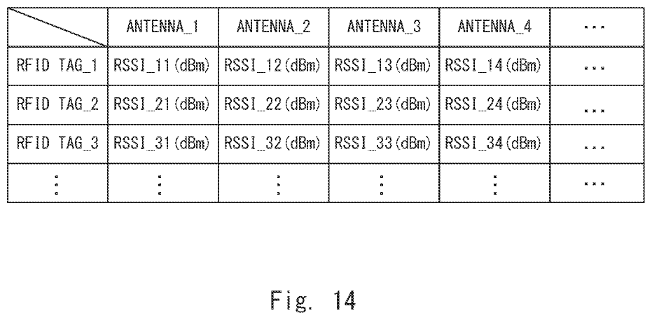

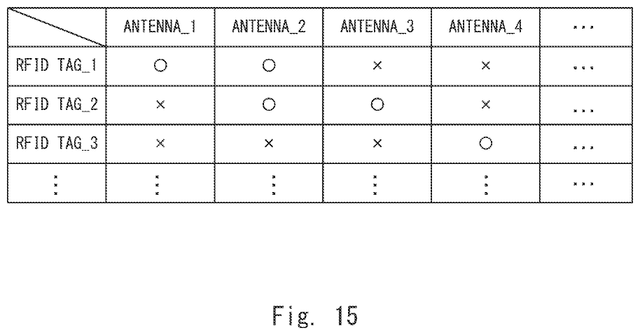

Further, even when the number of antennas 110 included in the array antennas 100 is large, the position of the product 80 may not be precisely determined depending on the receiving states of the radio wave transmitted from the same RFID tag 81 at the plurality of antennas 110. Therefore, the display control unit 403 may display (or indicate) an existence range of the product 80 to be removed (i.e., a range within which the product 80 to be removed is present) (i.e., an existence area) as shown in FIG. 12 or 13. Note that, in the example shown in FIG. 12, images 860 indicating the existence ranges of the products 80 to be removed are displayed together with images imitating the display shelves 90 (specifically, images 910 imitating shelf boards 91). Further, in the example shown in FIG. 13, light-emitting units 95 corresponding to the existence range emit light. Note that, in the example shown in FIG. 13, light-emitting units 95 with hatching represents light-emitting units 95 that are emitting light. In order to perform the above-described display control, the receiving strength of each of the antennas 110 for each of the RFID tags 81 may be managed in the display control unit 403 or the antenna control unit 200 as shown in FIG. 14 or 15. In the example shown in FIG. 14, a table for managing a value of the receiving strength of each of the antennas 110 for each of the RFID tags 81 is shown. Further, in the example shown in FIG. 15, a table for managing, for each of the RFID tags 81, whether or not the receiving strength of each of the antennas 110 is larger than a predetermined threshold is shown. In FIG. 15, each circle indicates that a receiving strength is larger than the predetermined threshold, and each cross indicates that a receiving strength is not larger than the predetermined threshold. For example, an area corresponding to an antenna(s) 110 at which the receiving strength for the RFID tag 81 of a product 80 to be removed is larger than the predetermined threshold can be defined as the existence range of this product 80.

Note that, in this example embodiment, the position of the product 80 in the height direction is also determined by providing the array antenna 100B as described above. However, when the determination of the position in the height direction is unnecessary, the array antenna 100B is not indispensable.

Next, a hardware configuration of the terminal device 400 will be described. FIG. 16 is a schematic diagram showing an example of the hardware configuration of the terminal device 400. As shown in FIG. 16, the terminal device 400 includes a communication interface 450, a memory 451, a processor 452, and a display 453.

The communication interface 450 is used to communicate with other apparatuses. In this example embodiment, the communication interface 450 includes an interface for communicating with the RFID reader 300 and an interface for communicating with the DB server 500.

The memory 451 is composed of, for example, a combination of a volatile memory and a non-volatile memory. The memory 451 is used to store software (a computer program) including at least one instruction executed by the processor 452, and data used in various processes performed in the terminal device 400.

The processor 452 performs a process performed by each of the communication control unit 401, the product determination unit 402, and the display control unit 403 shown in FIG. 8 by loading the software (the computer program) from the memory 451 and executing the loaded software. The processor 452 may be, for example, a microprocessor, an MPU (Micro Processor Unit), or a CPU (Central Processing Unit). The processor 452 may include a plurality of processors.

As described above, the terminal device 400 has functions as a computer. Further, similarly, the DB server 500 includes a processor and a memory, and has functions as a computer. Note that each of the RFID reader 300 and the antenna control unit 200 may also include a processor and a memory, and have functions as a computer. Therefore, the functions of the RFID reader 300 and the antenna control unit 200 may be implemented by the execution of a program by a processor. As described above, those skilled in the art will understand that the functions of the product management system 10 can be implemented in various forms, i.e., solely by hardware, solely by software, or a combination thereof. That is, they are limited to neither hardware nor software.

Further, the above-described program can be stored in various types of non-Transitory computer readable media and thereby supplied to computers. The non-transitory computer readable Media includes various types of tangible storage media. Examples of the non-transitory computer readable media include a magnetic recording medium (such as a flexible disk, a magnetic tape, and a hard disk drive), a magneto-optic recording medium (such as a magneto-optic disk), a CD-ROM (Read Only Memory), a CD-R, and a CD-R/W, and a semiconductor memory (such as a mask ROM, a PROM (Programmable ROM), an EPROM (Erasable PROM), a flash ROM, and a RAM (Random Access Memory)). Further, the program can be supplied to computers by using various types of Transitory computer readable media. Examples of the transitory computer readable media include an electrical signal, an optical signal, and an electromagnetic wave. The transitory computer readable media can be used to supply programs to computer through a wire communication path such as an electrical wire and an optical fiber, or wireless communication path.

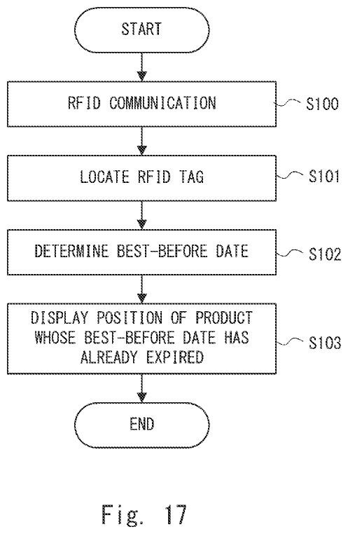

Next, operations performed by the product management system 10 will be described. FIG. 17 is a flowchart showing an example of a flow of operations performed by the product management system 10. The flow of operations performed by the product management system 10 will be described hereinafter with reference to FIG. 17.

In a step S100, the RFID reader 300 performs a process for reading information stored in RFID tags 81 attached to products 80 through the antenna control unit 200 and the array antennas 100. Therefore, the RFID tags 81 transmit information stored therein one after another (i.e., one RFID tag 81 after another).

In a step S101, the antenna control unit 200 locates each of the RFID tags 81 (i.e., determines the position of each of the RFID tags 81) based on the receiving state of each of the antennas 110.

In a step S102, the product determination unit 402 makes decisions on the best-before dates of the products 80 to which the RFID tags 81 are attached based on the information acquired by the communication control unit 401 (the information stored in the RFID tags 81).

In a step S103, the display control unit 403 performs control so as to display (or indicate) the position(s) of the product(s) to be removed.

The product management system 10 has been described above. According to the product management system 10, since the best-before date is checked and the position of the RFID tag 81 (the product 80) is determined through communication with the RFID tag 81, the position of the product 80 to be removed is automatically determined. Therefore, a person who takes charge of products 80 can easily find a product(s) 80 to be removed.

Note that the present invention is not limited to the above-mentioned example embodiments, and they may be changed as appropriate without departing from the scope and spirit of the invention. For example, although the above-described example embodiments are described by using the best-before date as an example of the expiration date, the product determination unit 402 may make a decision on any type of expiration date. For example, when a use-by date of a product 80 has been specified, the product determination unit 402 may make a decision on this use-by date.

Further, the product determination unit 402 may determine a state of a product other than the expiration date. For example, the product determination unit 402 may determine whether or not a product 80 is regarded as a defective product. Specifically, the product determination unit 402 may determine whether or not information about a product transmitted from the RFID tag 81 thereof matches information for defective products. For example, the product determination unit 402 may determine whether or not identification information of a product 80 transmitted from the RFID tag 81 thereof matches identification information of a product that has been determined as a defective product. Note that the determination as to a defective product may be made based on information other than the identification information. For example, in the case where a defective product can be identified based on the manufacturing date, the product determination unit 402 may determine whether or not a product 80 is regarded as a defective product based on the manufacturing date of the product 80. In this case, the display control unit 403 performs control so as to display the position of the product 80 regarded as being the defective product. According to the above-described configuration, it is possible to easily find a defective product(s) from the display shelf 90.

Further, the whole or part of the example embodiments disclosed above can be described as, but not limited to, the following supplementary notes.

### (Supplementary Note 1)

A product management system comprising:

a plurality of first antennas arranged in a shelf board of a display shelf in an orderly manner and configured to receive a radio wave from an RFID tag attached to a product displayed on the display shelf;

tag location means for locating the product based on a position of each of the first antennas and a receiving state of a radio wave transmitted from the same RFID tag at each of the first antennas;

product determination means for determining, based on information for specifying an expiration date of the product transmitted from the RFID tag by the radio wave, whether or not a remaining period from a present time to the expiration date satisfies a predetermined condition; and

display control means for performing control so as to display a position of the product whose remaining period satisfies the predetermined condition.

### (Supplementary Note 2)

The product management system described in Supplementary note 1, further comprising a plurality of second antennas arranged in a rear surface or a side surface of the display shelf in an orderly manner and configured to receive a radio wave from the RFID tag, wherein

the tag location means three-dimensionally locates the product based on a position of each of the first and second antennas and a receiving state of the radio wave transmitted from the same RFID tag at each of the first and second antennas.

### (Supplementary Note 3)

The product management system described in Supplementary note 1 or 2, wherein the display control means displays an image in which a position of a product of which the remaining period satisfies the predetermined condition is specified on an image imitating the display shelf.

### (Supplementary Note 4)

The product management system described in Supplementary note 3, wherein the display control means displays, along with the position of the product of which the remaining period satisfies the predetermined condition, information about an appearance of the product.

### (Supplementary Note 5)

The product management system described in any one of Supplementary notes 1 to 4, wherein

the display shelf comprises a plurality of light-emitting means arranged along an arranging direction of products, and

the display control means makes light-emitting means corresponding to a position of a product of which the remaining period satisfies the predetermined condition emit light.

### (Supplementary Note 6)

The product management system described in any one of Supplementary notes 1 to 5, wherein

the product determination means further determines whether or not information about the product transmitted from the RFID tag by the radio wave matches information for a defective product, and

the display control means further performs control so as to display a position of a product regarded as being the defective product.

### (Supplementary Note 7)

The product management system described in any one of Supplementary notes 1 to 6, wherein the first antennas are two-dimensionally arranged in the shelf board.

### (Supplementary Note 8)

The product management system described in Supplementary note 2, wherein the second antennas are two-dimensionally arranged in the rear surface or the side surface.

### (Supplementary Note 9)

The product management system described in any one of Supplementary notes 1 to 8, wherein the expiration date is a best-before date of the product.

### (Supplementary Note 10)

A product management method comprising:

locating a product displayed on a display shelf based on positions of a plurality of first antennas arranged in a shelf board of the display shelf in an orderly manner and configured to receive a radio wave from an RFID tag attached to the product and a receiving state of a radio wave transmitted from the same RFID tag at each of the first antennas;

determining, based on information for specifying an expiration date of the product transmitted from the RFID tag by the radio wave, whether or not a remaining period from a present time to the expiration date satisfies a predetermined condition; and

performing control so as to display a position of the product whose remaining period satisfies the predetermined condition.

### (Supplementary Note 11)

A non-transitory computer readable medium storing a program for causing a computer to perform:

a tag location step of locating a product displayed on a display shelf based on positions of a plurality of first antennas arranged in a shelf board of the display shelf in an orderly manner and configured to receive a radio wave from an RFID tag attached to the product and a receiving state of a radio wave transmitted from the same RFID tag at each of the first antennas;

a product determination step of determining, based on information for specifying an expiration date of the product transmitted from the RFID tag by the radio wave, whether or not a remaining period from a present time to the expiration date satisfies a predetermined condition; and

a display control step of performing control so as to display a position of the product whose remaining period satisfies the predetermined condition.

Although the present invention is described above with reference to example embodiments, the present invention is not limited to the above-described example embodiments. Various modifications that can be understood by those skilled in the art can be made to the configuration and details of the present invention within the scope of the invention.

This application is based upon and claims the benefit of priority from Japanese patent application No. 2019-150500, filed on Aug. 20, 2019, the disclosure of which is incorporated herein in its entirety by reference.

### REFERENCE SIGNS LIST

1 PRODUCT MANAGEMENT SYSTEM
2 ANTENNA
3 TAG LOCATION UNIT
4 PRODUCT DETERMINATION UNIT
5 DISPLAY CONTROL UNIT
10 PRODUCT MANAGEMENT SYSTEM
80 PRODUCT
81 RFID TAG
90 DISPLAY SHELF
91 SHELF BOARD
91_1 LOWER-SIDE SHELF BOARD
91_2 UPPER-SIDE SHELF BOARD
92 REAR BOARD
93_1 SIDE BOARD
93_2 SIDE BOARD
95 LIGHT-EMITTING UNIT
100 ARRAY ANTENNA
110 ANTENNA
200 ANTENNA CONTROL UNIT
300 RFID READER
400 TERMINAL DEVICE
401 COMMUNICATION CONTROL UNIT
402 PRODUCT DETERMINATION UNIT
403 DISPLAY CONTROL UNIT
450 COMMUNICATION INTERFACE
451 MEMORY
452 PROCESSOR
453 DISPLAY
500 DB SERVER

What is claimed is:

1. A product management system comprising:
a plurality of first antennas arranged in a shelf board of a display shelf in an orderly manner and configured to receive a radio wave from an RFID tag attached to a product displayed on the display shelf;
at least one memory storing program instructions; and
at least one processor configured to execute the instructions stored in the memory to:
locate the product based on a position of each of the first antennas and a receiving state of a radio wave transmitted from the same RFID tag at each of the first antennas;
determine, based on information for specifying an expiration date of the product transmitted from the RFID tag by the radio wave, whether or not a remaining period from a present time to the expiration date satisfies a predetermined condition; and
perform control so as to display a position of the product whose remaining period satisfies the predetermined condition.

2. The product management system according to claim 1, further comprising a plurality of second antennas arranged in a rear surface or a side surface of the display shelf in an orderly manner and configured to receive a radio wave from the RFID tag, wherein
the processor is further configured to execute the instructions to three-dimensionally locate the product based on a position of each of the first and second antennas and a receiving state of the radio wave transmitted from the same RFID tag at each of the first and second antennas.

3. The product management system according to claim 1, wherein the processor is further configured to execute the instructions to display an image in which a position of a product of which the remaining period satisfies the predetermined condition is specified on an image imitating the display shelf.

4. The product management system according to claim 3, wherein the processor is further configured to execute the instructions to display, along with the position of the product of which the remaining period satisfies the predetermined condition, information about an appearance of the product.

5. The product management system according to claim 1, wherein
the display shelf comprises a plurality of light-emitting units arranged along an arranging direction of products, and
the processor is further configured to execute the instructions to make the light-emitting unit corresponding to a position of a product of which the remaining period satisfies the predetermined condition emit light.

6. The product management system according to claim 1, wherein the processor is further configured to execute the instructions to
determine whether or not information about the product transmitted from the RFID tag by the radio wave matches information for a defective product, and
perform control so as to display a position of a product regarded as being the defective product.

7. The product management system according to claim 1, wherein the first antennas are two-dimensionally arranged in the shelf board.

8. The product management system according to claim 2, wherein the second antennas are two-dimensionally arranged in the rear surface or the side surface.

9. The product management system according to claim 1, wherein the expiration date is a best-before date of the product.

10. A product management method comprising:
locating a product displayed on a display shelf based on positions of a plurality of first antennas arranged in a shelf board of the display shelf in an orderly manner and configured to receive a radio wave from an RFID tag attached to the product and a receiving state of a radio wave transmitted from the same RFID tag at each of the first antennas;
determining, based on information for specifying an expiration date of the product transmitted from the RFID tag by the radio wave, whether or not a remaining period from a present time to the expiration date satisfies a predetermined condition; and
performing control so as to display a position of the product whose remaining period satisfies the predetermined condition.

11. A non-transitory computer readable medium storing a program for causing a computer to perform:
a tag location step of locating a product displayed on a display shelf based on positions of a plurality of first antennas arranged in a shelf board of the display shelf in an orderly manner and configured to receive a radio wave from an RFID tag attached to the product and a receiving state of a radio wave transmitted from the same RFID tag at each of the first antennas;
a product determination step of determining, based on information for specifying an expiration date of the product transmitted from the RFID tag by the radio wave, whether or not a remaining period from a present time to the expiration date satisfies a predetermined condition; and
a display control step of performing control so as to display a position of the product whose remaining period satisfies the predetermined condition.
